(19) United States
(12) Patent Application Publication
(10) Pub. No.: US 2007/0061071 A1
(43) Pub. Date: Mar. 15, 2007

(54) Routing assistance system

(75) Inventor: Akira Torii, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/516,502

(22) Filed: Sep. 7, 2006

(30) Foreign Application Priority Data
Sep. 15, 2005 (JP) JP2005 268477

(51) Int. Cl. G01C 21/00

(52) U.S. Cl. 701/209; 701/211; 701/200; 701/201; 340/995.23

(57) ABSTRACT

When a directed route is set by specifying a departure point and destination point, a navigation system acquires unwanted-area information that represents an area for which route guidance is unwanted. The navigation system then sets a guidance starting point and a guidance terminating point, based on the acquired unwanted-area information. The system selectively provides route guidance to the user in the form of voice and picture with respect to a route from the guidance starting point to the guidance terminating point, within the directed route.

### CROSS REFERENCE TO RELATED APPLICATION

This application is based on and incorporates herein by reference Japanese Patent Application No. 2005-268477 filed on Sep. 15, 2005.

### FIELD OF THE INVENTION

The present invention relates to a routing assistance system that, when a destination point is specified through a user interface, presents a route from a predetermined departure point to the specified destination point in the form of voice and picture.

### BACKGROUND OF THE INVENTION

As a routing assistance system, car navigation systems mounted in vehicles have been conventionally known. As one of this type of routing assistance system, those that carry out the following processing have been known: when a destination point is specified by a user through a user interface, the system sets a directed route from the current position of the relevant vehicle at this point of time to the specified destination point. Then, it provides routing assistance or route guidance in the form of voice or picture so that the user can drive his/her vehicle along this directed route to the destination point.

As a method for providing route guidance in the form of voice, there is known a method in which the user is informed by voice that he/she should make a right or left turn at an intersection, according to the current position of the vehicle. As a method for providing route guidance in the form of picture, there is known a method in which a map of the area around the current position of the relevant vehicle is displayed on a display device and a directed route is displayed over this map.

It cannot be said that route guidance by this type of routing assistance system can always present the optimum route to the user. In an area familiar to the user, for example, the area in proximity to the user's home, the user may not follow guidance by the routing assistance system, and the user may take any other route. In cases where a user drives his/her vehicle off a directed route, as mentioned above, the following take place: voice saying that the vehicle has deviated from the directed route is outputted; and, though unnecessary for the user, rerouting processing is carried out in the routing assistance system and the user is provided with unnecessary route guidance.

The sustention of route guidance, unnecessary for the user, causes stress on the user as a matter of course. To cope with this, conventional routing assistance systems take the following measure: based on the record of guidance in the past and information on registered points, it is determined whether or not voice guidance is required at a point where guidance is supposed to be provided; when it is determined that voice guidance is unnecessary, voice guidance is not provided or the frequency of voice guidance is changed. (Refer to Patent Documents 1, 2, and 3, for example.)
Patent Document 1: JP-2002-236028 A
Patent Document 2: JP-H11-201767 A
Patent Document 3: JP-2002-139335 A

However, in conventional systems, route guidance using a display device is not stopped even after voice guidance is stopped. For this reason, when a user drives his/her vehicle off a directed route, a conventional system performs update of a screen associated with route guidance unnecessary for the user. This results in stress on the user.

An example will be taken up. As a routing assistance system, there is known a routing assistance system so designed that the following processing is carried out: ordinarily, a map of the area around the current position is displayed on a display device; in proximity to an intersection where the vehicle is supposed to make a right or left turn, a route guidance screen showing the three-dimensional image of the area around the intersection is displayed for route guidance. In this routing assistance system, the above-mentioned route guidance screen is displayed at every intersection as the result of rerouting processing during route guidance. Since the screen unnecessarily changes, therefore, the user sometimes feels stressed.

This is the case especially when a user uses a routing assistance system in such a manner that he/she does not follow directed routes but checks a road he/she should take by a map displayed on a display device. Since the screen is updated because of unnecessary route guidance, the user cannot check a road he/she should take and may feel inconvenience.

### SUMMARY OF THE INVENTION

The invention has been made with the above-mentioned problems taken into account. It is an object of the invention to provide a technique that makes it possible for a user to prevent the provision of route guidance unnecessary for the user in a routing assistance system that provides route guidance in the form of voice and picture.

According to an aspect of the present invention, a routing assistance system is provided with the following. A route setting means sets a route from a departure point to a destination point. A route guidance means provides route guidance. An acquiring means acquires unwanted-area information that represents an area for which route guidance is unwanted. A point setting means sets, within the route set by the route setting means, a guidance starting point and a guidance terminating point in the route, based on the acquired unwanted-area information. The route guidance means provides route guidance with respect to a route from the guidance starting point to the guidance terminating point.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating the configuration of an automobile navigation system;

FIG. 2A is an explanatory drawing illustrating the construction of a guidance control point database, and FIGS. 2B and 2C are explanatory drawings related to a method for setting a nonexecution area of route guidance based on guidance control point data;

FIG. 3A is an explanatory drawing illustrating the construction of a guidance prohibition area database, and FIGS. 3B and 3C are explanatory drawings related to a method for setting a nonexecution area of route guidance based on guidance prohibition area data;

FIG. 4 is a flowchart illustrating the navigation control processing carried out by a control unit;

FIG. 5 is a flowchart illustrating the processing to set a departure point guidance unwanted area, carried out by the control unit;

FIG. 6 is an explanatory drawing illustrating a region R for which guidance control point data is read out;

FIG. 7 is an explanatory drawing illustrating the construction of the setting screen for departure point (destination) guidance unwanted area;

FIG. 8 is a flowchart illustrating the processing to set a destination guidance unwanted area, carried out by the control unit;

FIG. 9 is a flowchart illustrating the route search and notification processing carried out by the control unit;

FIG. 10 is a flowchart illustrating the guided route notification processing carried out by the control unit;

FIG. 11 is an explanatory drawing illustrating the guided route notification screen displayed on a display unit;

FIG. 12 is a flowchart illustrating the processing to control turn-on/off of route guidance, carried out by the control unit;

FIG. 13 is an explanatory drawing of processing associated with route guidance;

FIG. 14 is a flowchart illustrating a first processing to control the start of guidance, carried out by the control unit;

FIG. 15 is a flowchart illustrating a second processing to control the start of guidance, carried out by the control unit;

FIG. 16 is a flowchart illustrating a first processing to control the termination of guidance, carried out by the control unit;

FIG. 17 is a flowchart illustrating a second processing to control the termination of guidance, carried out by the control unit; and

FIG. 18 is a flowchart illustrating a third processing to control the termination of guidance, carried out by the control unit.

### DETAILED DESCRIPTION OF THE PREFERRED EMBODIMENTS

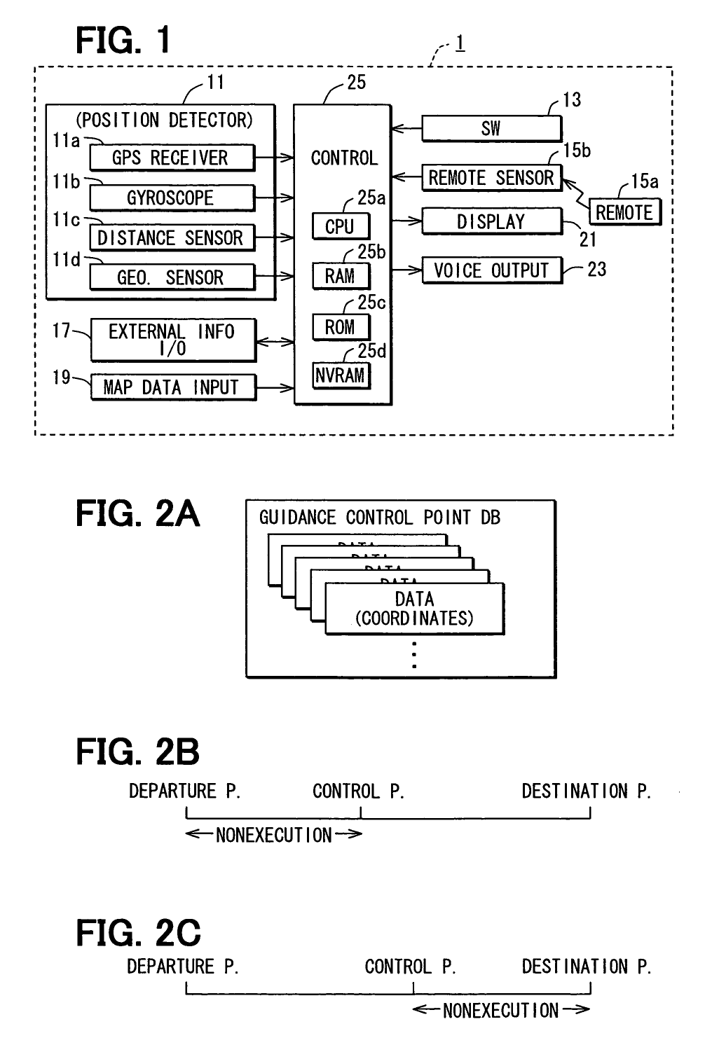

Hereafter, description will be given of an embodiment of the invention with reference to the drawings. FIG. 1 is a block diagram illustrating the configuration of an automobile navigation system 1 including a function of a routing assistance system, mounted in a vehicle (automobile), to which the invention is applied.

As illustrated in FIG. 1, the automobile navigation system 1 in a vehicle in this embodiment includes: a position detector 11 that detects the current position of the vehicle; an operation switch group 13 and a remote control terminal (hereafter, referred to as remote) 15a that function as user interfaces; a remote sensor 15b that senses transmission signals from the remote 15a; an external information input/output unit 17 that communicates information with external devices; a map data input device 19 that reads map data and the like from storage media; a display unit 21 for displaying maps, the route guidance screen, and the like; a voice output unit 23 for outputting varied audio guidance; and a control unit 25 that carries out varied processing according to inputs from the above-mentioned position detector 11, operation switch group 13, remote sensor 15b, external information input/output unit 17, and map data input device 19, and controls the various parts in the system.

The position detector 11 includes: a GPS receiver 11a that receives radio waves transmitted from artificial satellites for GPS (Global Positioning System) through a GPS antenna and detects the position, orientation, speed, and the like of the vehicle; a gyroscope 11b that detects the magnitude of rotational motion applied to the vehicle; a distance sensor 11c that detects the travel distance of the vehicle; and a geomagnetic sensor 11d that detects a traveling azimuth from geomagnetism.

The operation switch group 13 is constructed of: a touch panel constructed integrally with the display unit 21; mechanical key switches provided around the display unit 21; and the like. The external information input/output unit 17 is so constructed that it communicates information with beacons installed as external devices on roads, and acquires road traffic information and the like from a VICS (Vehicle Information and Communication System) center through these beacons.

The map data input device 19 is so designed as to input map data and the like, stored in storage media, not shown, to the control unit 25. In storage media, the following are stored as map data: data indicating road connections (data on links and nodes), geographical data, facility data, and the like as well as data for map matching for enhancement of position detection accuracy, data under voice for routing assistance or route guidance, and the like. Storage media include such media as CD-ROM, DVD, hard disk, and the like.

The display unit 21 is a color display device and is constructed of a liquid crystal monitor and the like. Under the control of the control unit 25, the display unit 21 displays a map of the area around the current position of the vehicle, a route to a destination point specified by the user, and the like. The voice output unit 23 is constructed of a speaker and the like. Under the control of the control unit 25, it produces the output of audio guidance associated with route guidance with respect to routes to a destination point and the output of audio guidance based on road traffic information received through the external information input/output unit 17.

The control unit 25 is constructed of CPU 25a, RAM 25b, ROM 25c, NVRAM 25d that stores varied setting information, and the like. It executes various programs stored in the ROM 25c, using the CPU 25a, and thereby controls each part of the system in a centralized manner and carries out a map display function, a function of route guidance with respect to routes to a destination point, and the like.

For example, the control unit 25 performs the following operations: it computes the current position of the vehicle as a set of position coordinates (latitude and longitude) and a traveling direction based on various detection signals from the position detector 11; it acquires map data on the area around the current position of the vehicle from the map data input device 19 based on the result of computation; and it causes the display unit 21 to display the map of the area around the current position of the vehicle based on this map data.

When a route guidance command is inputted from the user through the operation switch group 13, remote 15a, or the like, the control unit 25 computes the optimum route from the point at which the vehicle is located when the command is inputted to a destination point specified by this command, using a publicly known technique such as the Dijkstra method. Then, the control unit 25 provides this route guidance through the display unit 21 and the voice output unit 23. Specifically, route guidance is provided as follows: a map of the area around the current position of the vehicle is displayed on the display unit 21; and a guided route is displayed over the map using heavy line or the like. Further, as the vehicle moves closer to an intersection, it indicates the turning direction of the vehicle by voice through the voice output unit 23.

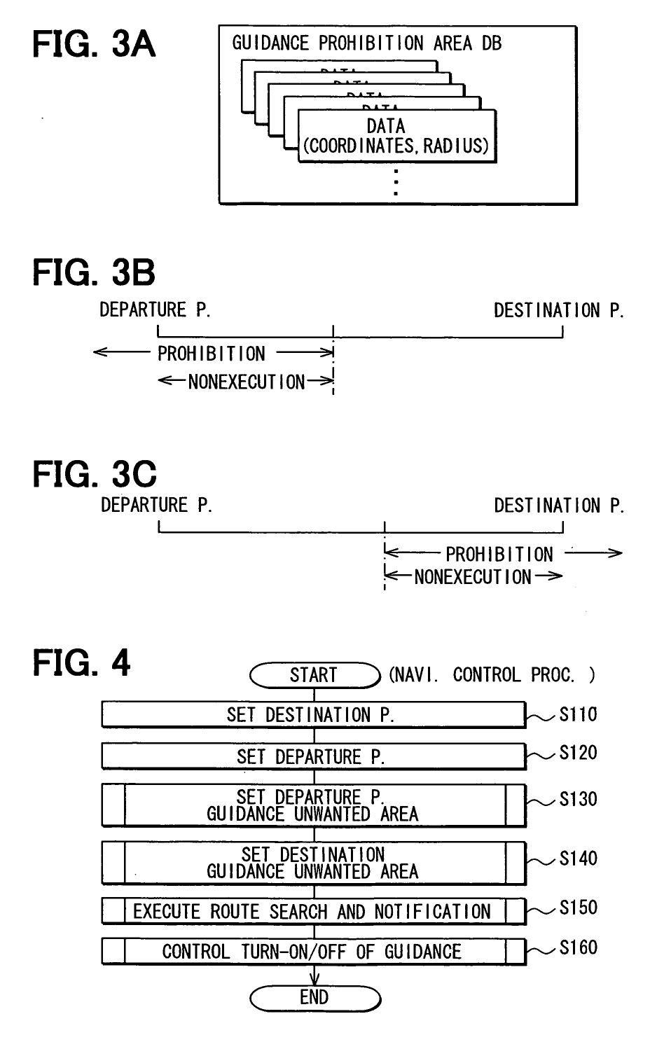

The automobile navigation system 1 in this embodiment is so constructed that, when a route guidance command is inputted from a user, it carries out the following processing: based on information held in a guidance control point database and a guidance prohibition area database, it provides route guidance only in a specific route section in the route from the current position of the vehicle to a destination point specified by this command. FIG. 2A is an explanatory drawing illustrating the construction of the guidance control point database, and FIG. 3A is an explanatory drawing illustrating the construction of the guidance prohibition area database. In this embodiment, the guidance control point database and the guidance prohibition area database are stored in the NVRAM 25d.

As illustrated in FIG. 2A, the guidance control point database is constructed of a group of pieces of guidance control point data containing information on sets of coordinates (latitude and longitude). The positional information (information on latitude and longitude) indicated by each piece of guidance control point data is used as information that indicates points at which route guidance should be turned on/off.

As illustrated in FIG. 3A, the guidance prohibition area database is constructed of a group of pieces of guidance prohibition area data containing information on central point and radius. The area information (information on central point and radius) indicated by each piece of guidance prohibition area data is used as the following information: information in which an area where route guidance is prohibited (guidance prohibition area) is indicated by a circular area defined by a central point and a radius. The information on central point consists of information on a set of coordinates (latitude and longitude).

—Navigation Control Processing

Up to this point, description has been given of the general configuration of the automobile navigation system 1 and the construction of data held in the system. Next, description will be given of navigation control processing carried out by the control unit 25 when a route guidance command is inputted from a user through the operation switch group 13, remote 15a, or the like. FIG. 4 is a flowchart illustrating the navigation control processing carried out by the control unit 25.

When navigation control processing is started, the control unit 25 sets a point, specified by the route guidance command, as the destination point (S110), and further derives the current position of the vehicle (latitude and longitude) and sets this current position of the vehicle as the departure point (S120). The route guidance command is inputted by the user's performing the following operation, for example: he/she scrolls the map displayed on the display unit 21, and positions the pointer at the destination point; in this state, he/she presses a specific key provided in the operation switch group 13 or the remote 15a.

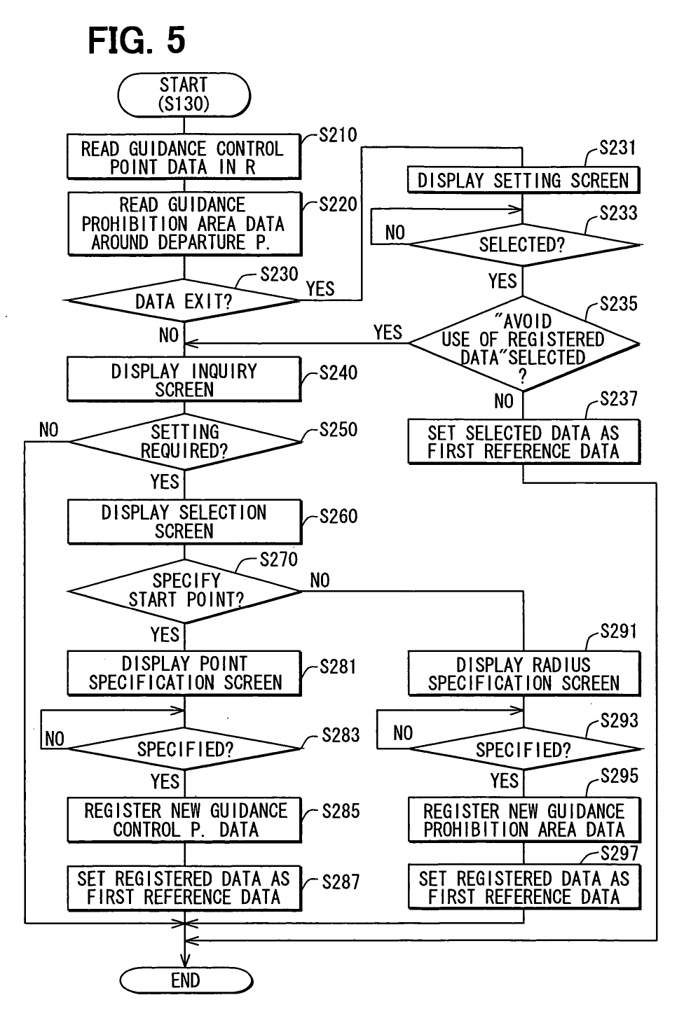

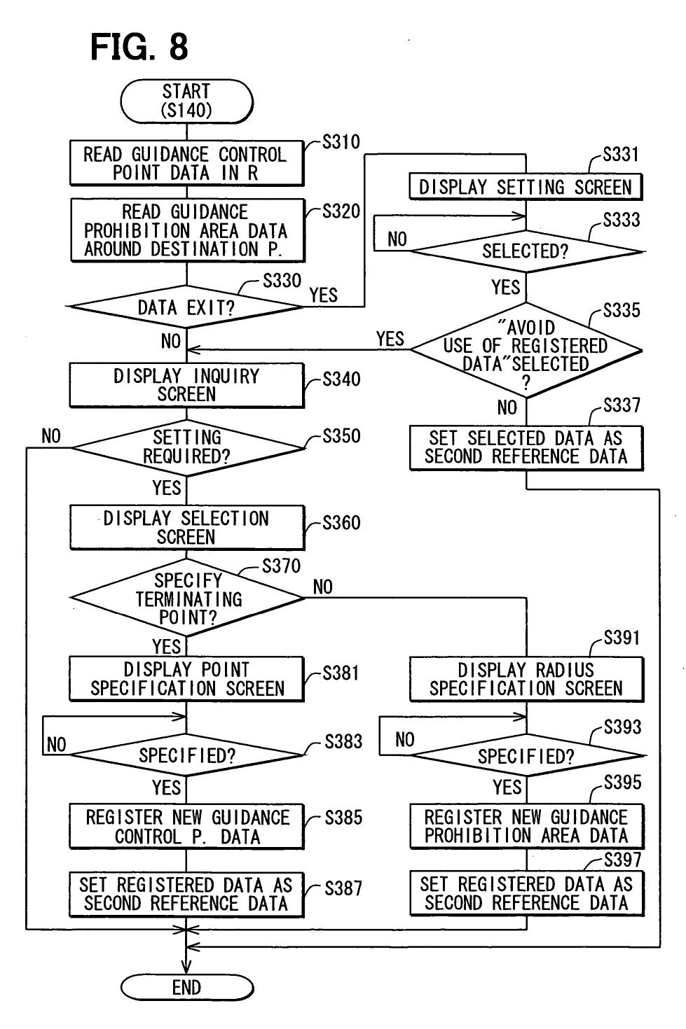

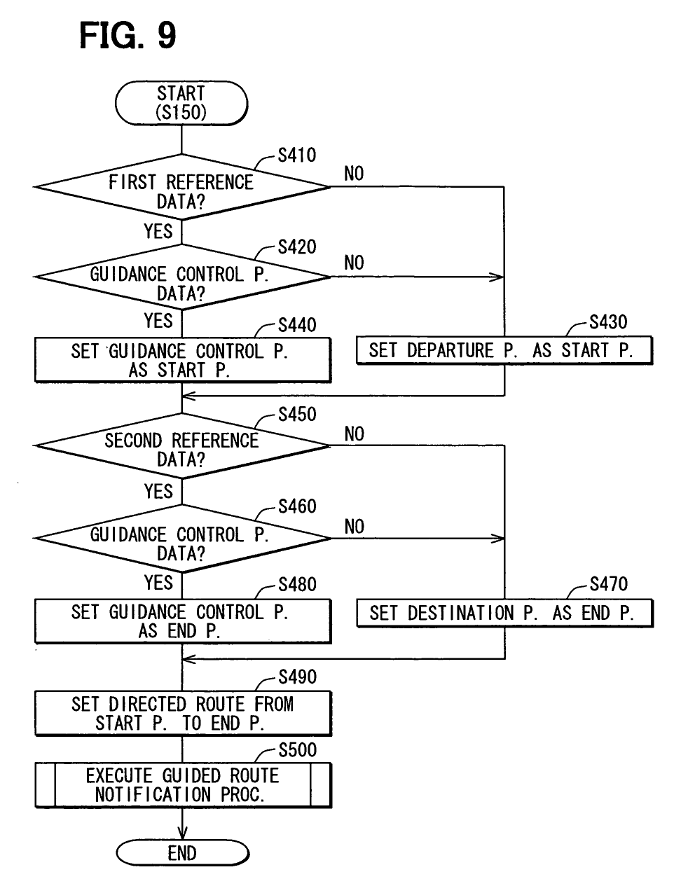

After the completion of the processing of S120, the control unit 25 proceeds to subsequent steps S130 to S160 as follows: (i) S130 to set a departure point guidance unwanted area, illustrated in FIG. 5; (ii) S140 to set a destination guidance unwanted area, illustrated in FIG. 8; (iii) S150 to execute route search and notification processing, illustrated in FIG. 9; and (iv) S160 to control turn-on/off of route guidance, illustrated in FIG. 12.

(i) Processing to Set a Departure Point Guidance Unwanted Area

FIG. 5 is a flowchart illustrating the processing to set a departure point guidance unwanted area, carried out by the control unit 25.

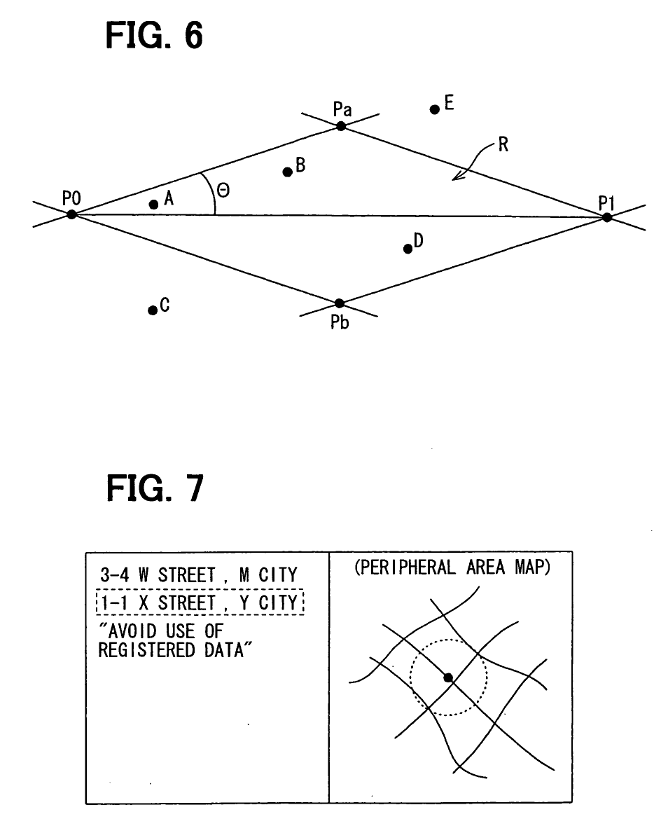

When the processing to set a departure point guidance unwanted area is started, the control unit 25 carries out the following processing. It takes as the axis line the straight line that connects the destination point P1 and the departure point P0 respectively set at S110 and S120 (Refer to FIG. 6). The control unit 25 determines points Pa and Pb of intersection as follows. First two straight lines which pass through the departure point P0 symmetrically relative to the axis line are drawn to have an angle of a predetermined value Θ (e.g. Θ=30 degrees) to this axis line; similarly, second two straight lines which pass through the departure point P1 symmetrically relative to the axis line are drawn to have an angle of the predetermined value Θ to this axis line. The points Pa and Pb are defined as intersections upward and downward in FIG. 6 between the first two straight lines and the second two straight lines. Then, the control unit 25 determines the region R defined by straight lines connecting the points P0, Pa, P1, and Pb. FIG. 6 is an explanatory drawing illustrating the region R.

Then, the control unit 25 reads all the pieces of guidance control point data indicating points in this region R from the guidance control point database (S210). Specifically, it reads guidance control point data indicating points indicated by latitude and longitude which are positioned in the region R from the guidance control point database. In the example illustrated in FIG. 6, the guidance control point data corresponding to points A, B, and D is guidance control point data to be read out.

After the completion of the processing of S210, the control unit 25 reads all the pieces of guidance prohibition area data in which the departure point is contained in a guidance prohibition area from the guidance prohibition area database (S220). That is, it reads guidance prohibition area data in which the departure point set at S120 is contained in circular areas indicated by guidance prohibition area data from the guidance prohibition area database.

After the completion of the processing of S220, the control unit 25 determines whether or not one or more pieces of data were read out at S210 or S220 (S230). In cases where one or more pieces of data were read out at S210 or S220, it makes an affirmative determination and proceeds to S231. In cases where data was not read out in the processing of S210 or S220, it makes a negative determination and proceeds to S240.

More specific description will be given. In cases where guidance control point data indicating a point located in the region R has been registered in the guidance control point database, the control unit 25 makes an affirmative determination at S230 and proceeds to S231. Also, in cases where guidance prohibition area data in which the departure point is contained in a guidance prohibition area has been registered in the guidance prohibition area database, the control unit 25 carries out the same processing. In cases where guidance control point data indicating a point located in the region R has not been registered in the guidance control point database and guidance prohibition area data in which the departure point is contained in a guidance prohibition area has not been registered in the guidance prohibition area database, the following takes place: the control unit 25 makes a negative determination at S230 and proceeds to S240.

After proceeding to S231, the control unit 25 causes the display unit 21 to display the setting screen for departure point guidance unwanted area, constructed as illustrated in FIG. 7, based on the pieces of data read out at S210 and S220. The setting screen shows as options the pieces of data indicating the addresses of points indicated by the individual pieces of data (central point in case of guidance prohibition area data) and an option consisting of a character string reading “Avoid use of registered data.”

FIG. 7 is an explanatory drawing illustrating the construction (example) of the setting screen for departure point guidance unwanted area. As illustrated in FIG. 7, the options corresponding to the above-mentioned individual pieces of data are displayed in the left field of the setting screen for departure point guidance unwanted area.

At S231, the control unit 25 accepts the user's cursor operation, and displays a point indicated by data corresponding to the option at which the user positions the cursor in the left field of the setting screen for departure point guidance unwanted area by the user's cursor operation. (In case of guidance prohibition area data, it displays a circular area on the basis of the central point.) The control unit 25 displays the point in the right field of the setting screen for departure point guidance unwanted area, together with the map of the peripheral area.

When the user operates the operation switch group 13 or the remote 15a in this screen and selects any of the options listed in the left field (for example, the Enter key is pressed), the control unit 25 makes an affirmative determination at S233. Then, it determines whether or not the selected option (option at which the cursor was positioned when the Enter key was pressed) is the option of “Avoid use of registered data” (S235). When the control unit 25 determines that the selected option is the option of “Avoid use of registered data” (Yes at S235), it proceeds to S240. When the control unit 25 determines that the selected option is any option other than the option of “Avoid use of registered data” (No at S235), it proceeds to S237.

After proceeding to S237, the control unit 25 sets the guidance control point data or guidance prohibition area data corresponding to the selected option as first reference data. The first reference data is data referred to when a starting point for route guidance is determined. Thereafter, the control unit 25 terminates this processing to set a departure point guidance unwanted area.

After proceeding to S240, meanwhile, the control unit 25 causes the display unit 21 to display a setting necessity inquiry screen that is for inquiring whether or not it is required to set a departure point guidance unwanted area. Then, the control unit 25 waits until the user inputs a signal indicating that setting is required or a signal indicating that setting is not required through the operation switch group 13 or the remote 15a (S250). When a signal indicating that setting is required is inputted from the operation switch group 13 or the remote 15a, the control unit 25 makes an affirmative determination at S250, and proceeds to S260. When a signal indicating that setting is not required is inputted from the operation switch group 13 or the remote 15a, the control unit 25 makes a negative determination at S250, and terminates this processing to set a departure point guidance unwanted area.

After proceeding to S260, the control unit 25 causes the display unit 21 to display a selection screen related to a method for specifying a departure point guidance unwanted area. Specifically, it causes the display unit 21 to display the selection screen in which the following character strings are indicated as options: a character string reading “Specify starting point for route guidance” and a character string reading “Specify prohibition area for route guidance with departure point taken as a base point.”

Thereafter, the control unit 25 waits until the user operates the operation switch group 13 or the remote 15a in this selection screen and thereby selects a method for specifying a departure point guidance unwanted area. When a method for specifying a departure point guidance unwanted area is selected, the control unit 25 determines whether or not the selected method is a method of “Specify starting point for route guidance” (S270). When the control unit 25 determines that the selected method is a method of “Specify starting point for route guidance” (Yes at S270), it proceeds to S281. When the control unit 25 determines that the selected method is a method of “Specify prohibition area for route guidance with departure point taken as a base point” (No at S270), it proceeds to S291.

After proceeding to S281, the control unit 25 causes the display unit 21 to display a point specification screen for making the user specify a starting point for route guidance (e.g. a scrollable map screen). Then, it waits until the user operates the operation switch group 13 or the remote 15a in this point specification screen and thereby specifies a starting point for route guidance. When a starting point for route guidance is specified by the user (Yes at S283), the control unit 25 proceeds to S285.

After proceeding to S285, the control unit 25 newly generates guidance control point data in which the positional information (information on latitude and longitude) about the specified point is described, and registers it in the guidance control point database. After the completion of the processing of S285, the control unit 25 sets the registered guidance control point data as first reference data (S287), and then terminates this processing to set a departure point guidance unwanted area.

After proceeding to S291, meanwhile, the control unit 25 causes the display unit 21 to display a radius specification screen for acquiring radius information from the user. The radius information is required to determine a prohibition area for route guidance with the departure point (the current position of the vehicle) taken as a base point. Thus, the control unit 25 inquires of the user the range within how many meters in radius with the current position at the center should be taken as prohibition area for route guidance.

When radius information is inputted from the user through the operation switch group 13 or the remote 15a (Yes at S293), the control unit 25 adds the latitude and longitude of the current position as the information on the central point to this inputted radius information to newly generate guidance prohibition area data, and registers it in the guidance prohibition area database (S295).

When the control unit 25 completes the processing of S295, as mentioned above, it sets the registered guidance prohibition area data as first reference data (S297), and then terminates this processing to set a departure point guidance unwanted area.

When the control unit 25 terminates the above-mentioned processing to set a departure point guidance unwanted area at S130, it proceeds to S140, and carries out the processing to set a destination guidance unwanted area.

(ii) Processing to Set a Destination Guidance Unwanted Area

FIG. 8 is a flowchart illustrating the processing to set a destination guidance unwanted area, carried out by the control unit 25.

When the processing to set a destination guidance unwanted area is started, the control unit 25 reads all the pieces of guidance control point data indicating points in the region R from the guidance control point database, as in the processing of S210 (S310). Further, it reads all the pieces of guidance prohibition area data in which the destination point is contained in a guidance prohibition area from the guidance prohibition area database (S320). That is, it reads guidance prohibition area data in which the destination point is contained in circular areas indicated by guidance prohibition area data from the guidance prohibition area database.

After the completion of the processing of S320, the control unit 25 determines whether or not one or more pieces of data were read out at S310 or S320 (S330). In cases where one or more pieces of data were read out at S310 or S320, it makes an affirmative determination and proceeds to S331. In cases where data was not read out in the processing of S310 or S320, it makes a negative determination and proceeds to S340.

After proceeding to S331, the control unit 25 causes the display unit 21 to display the setting screen for destination guidance unwanted area based on the pieces of data read out at S310 and S320. The setting screen shows as options the pieces of data indicating the addresses of points indicated by the individual pieces of data (central points in case of guidance prohibition area data) and an option consisting of a character string reading “Avoid use of registered data.”

At S331, the control unit 25 accepts the user's cursor operation, and displays a point indicated by data corresponding to the option at which the user positions the cursor in the left field of the setting screen for destination guidance unwanted area. The control unit 25 displays the point in the right field of the setting screen for destination guidance unwanted area, together with the map of the peripheral area. The construction of this setting screen for destination guidance unwanted area is the same as the construction of the setting screen for departure point guidance unwanted area illustrated in FIG. 7.

When the user operates the operation switch group 13 or the remote 15a in this screen and selects any of the options listed in the left field, the control unit 25 makes an affirmative determination at S333. Then, it determines whether or not the selected option is the option of “Avoid use of registered data” (S335). When the control unit 25 determines that the selected option is the option of “Avoid use of registered data” (Yes at S335), it proceeds to S340. When the control unit 25 determines that the selected option is any option other than the option of “Avoid use of registered data” (No at S335), it proceeds to S337.

After proceeding to S337, the control unit 25 sets the guidance control point data or guidance prohibition area data corresponding to the selected option as second reference data. The second reference data is data referred to when a terminating point for route guidance is determined. Thereafter, the control unit 25 terminates this processing to set a destination guidance unwanted area.

After proceeding to S340, meanwhile, the control unit 25 causes the display unit 21 to display the setting necessity inquiry screen that is for inquiring whether or not it is required to set a destination guidance unwanted area. Then, the control unit 25 waits until the user inputs a signal indicating that setting is required or a signal indicating that setting is not required through the operation switch group 13 or the remote 15a (S350). When a signal indicating that setting is required is inputted from the operation switch group 13 or the remote 15a, the control unit 25 makes an affirmative determination at S350, and proceeds to S360. When a signal indicating that setting is not required is inputted from the operation switch group 13 or the remote 15a, the control unit 25 makes a negative determination at S350, and terminates this processing to set a destination guidance unwanted area.

After proceeding to S360, the control unit 25 causes the display unit 21 to display a selection screen related to a method for specifying a destination guidance unwanted area. Specifically, it causes the display unit 21 to display the selection screen in which the following character strings are indicated as options: a character string reading “Specify terminating point for route guidance” and a character string reading “Specify prohibition area for route guidance with destination point taken as a base point.”

Thereafter, the control unit 25 waits until the user operates the operation switch group 13 or the remote 15a in this selection screen and thereby selects a method for specifying a destination guidance unwanted area. When a method for specifying a destination guidance unwanted area is selected, the control unit 25 determines whether or not the selected method is a method of “Specify terminating point for route guidance” (S370). When the control unit 25 determines that the selected method is a method of “Specify terminating point for route guidance” (Yes at S370), it proceeds to S381. When the control unit 25 determines that the selected method is a method of “Specify prohibition area for route guidance with destination point taken as a base point” (No at S370), it proceeds to S391.

After proceeding to S381, the control unit 25 causes the display unit 21 to display a point specification screen for making the user specify a terminating point for route guidance. Then, it waits until the user operates the operation switch group 13 or the remote 15a in this point specification screen and thereby specifies a terminating point for route guidance. When a terminating point for route guidance is specified by the user (Yes at S383), the control unit 25 proceeds to S385.

After proceeding to S385, the control unit 25 newly generates guidance control point data in which the positional information (information on latitude and longitude) about the specified point is described, and registers it in the guidance control point database. After the completion of this processing, the control unit 25 sets the guidance control point data registered at S385 as second reference data (S387), and terminates this processing to set a destination guidance unwanted area.

After proceeding to S391, meanwhile, the control unit 25 causes the display unit 21 to display a radius specification screen for acquiring radius information from the user. The radius information is required to determine a prohibition area for route guidance with the destination point taken as a base point. Thus, the control unit 25 inquires of the user the range within how many meters in radius with the destination point at the center should be taken as prohibition area for route guidance.

When radius information is inputted from the user through the operation switch group 13 or the remote 15a (Yes at S393), the control unit 25 adds the latitude and longitude of the destination point set at S110 as the information on the central point to this inputted radius information to newly generate guidance prohibition area data, and registers it in the guidance prohibition area database (S395). When the control unit 25 completes this processing, it sets the guidance prohibition area data registered at S395 as second reference data (S397), and then terminates this processing to set a destination guidance unwanted area.

When the control unit 25 terminates the above-mentioned processing to set a destination guidance unwanted area at S140, it proceeds to S150, and carries out the route search and notification processing illustrated in FIG. 9.

(iii) Route Search and Notification Processing

FIG. 9 is a flowchart illustrating the route search and notification processing carried out by the control unit 25.

When the route search and notification processing is started, the control unit 25 determines whether or not first reference data has been set by the processing to set a departure point guidance unwanted area, previously carried out (S410). When it determines that first reference data has been set (Yes at S410), it proceeds to S420. When it determines that first reference data has not been set (No at S410), it proceeds to S430.

More specific description will be given. In cases where the processing of S237, S287, or S297 was carried out as the processing to set a departure point guidance unwanted area, the control unit 25 makes an affirmative determination at S410 and proceeds to S420. In cases where the control unit 25 made a negative determination at S250 in the processing to set a departure point guidance unwanted area previously carried out, it makes a negative determination at S410 as well, and proceeds to S430.

After proceeding to S420, the control unit 25 determines whether or not the first reference data set by the processing to set a departure point guidance unwanted area previously carried out is guidance control point data. When it determines that the first reference data is not guidance control point data (in other words, the first reference data is guidance prohibition area data) (No at S420), it proceeds to S430. At S430, the control unit 25 sets the departure point set at S120 as the start point for route search. Thereafter, it proceeds to S450.

Meanwhile, when the control unit 25 determines that the first reference data is guidance control point data (Yes at S420), it sets the point of turn-on/off of route guidance indicated by the first reference data as the start point for route search (S440), and then it proceeds to S450.

After proceeding to S450, the control unit 25 determines whether or not second reference data has been set by the processing to set a destination guidance unwanted area previously carried out. When it determines that second reference data has been set (Yes at S450), it proceeds to S460. When it determines that second reference data has not been set (No at S450), it proceeds to S470.

More specific description will be given. In cases where the processing of S337, S387, or S397 was carried out as the processing to set a destination guidance unwanted area, the control unit 25 makes an affirmative determination at S450 and proceeds to S460. In cases where the control unit 25 made a negative determination at S350 in the processing to set a destination guidance unwanted area previously carried out, it makes a negative determination at S450 as well, and proceeds to S470.

After proceeding to S460, the control unit 25 determines whether or not the second reference data set by the processing to set a destination guidance unwanted area previously carried out is guidance control point data. When it determines that the second reference data is not guidance control point data (No at S460), it proceeds to S470. At S470, the control unit 25 sets the destination point set at S110 as the end point for route search. Thereafter, it proceeds to S490.

Meanwhile, when the control unit 25 determines that the second reference data is guidance control point data (Yes at S460), it sets the point of turn-on/off of route guidance indicated by the second reference data as the end point for route search (S480), and then it proceeds to S490.

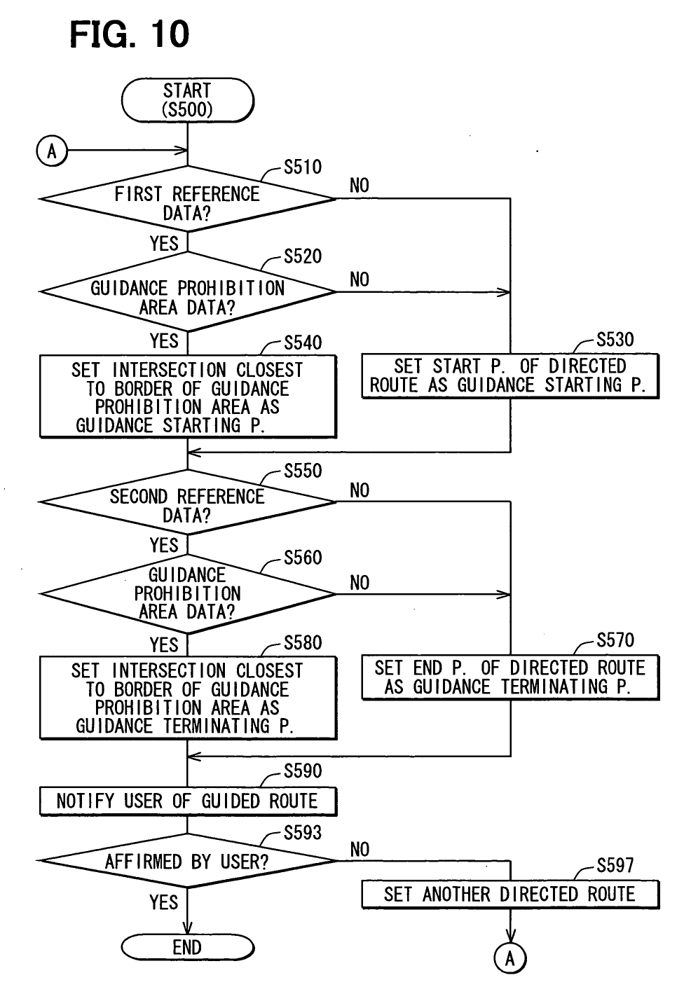

After proceeding to S490, the control unit 25 starts a route search program, and searches for the optimum route from the start point set at S430 or S440 to the end point set at S470 or S480, and sets the route obtained as the result of search as directed route. After the control unit 25 sets the directed route from the start point to the end point at S490, it proceeds to S500, and carries out the guided route notification processing illustrated in FIG. 10. FIG. 10 is a flowchart illustrating the guided route notification processing carried out by the control unit 25.

When the guided route notification processing is started, the control unit 25 determines whether or not first reference data has been set, as in the processing of S410 (S510). When it determines that first reference data has been set (Yes at S510), it proceeds to S520. When it determines that first reference data has not been set (No at S510), it proceeds to S530.

After proceeding to S520, the control unit 25 determines whether or not the first reference data set by the processing to set a departure point guidance unwanted area previously carried out is guidance prohibition area data. When it determines that the first reference data is not guidance prohibition area data (No at S520), it proceeds to S530. At S530, the control unit 25 sets the start point of the directed route (the start point set at S430 or S440) as the starting point for route guidance (guidance starting point). Thereafter, it proceeds to S550.

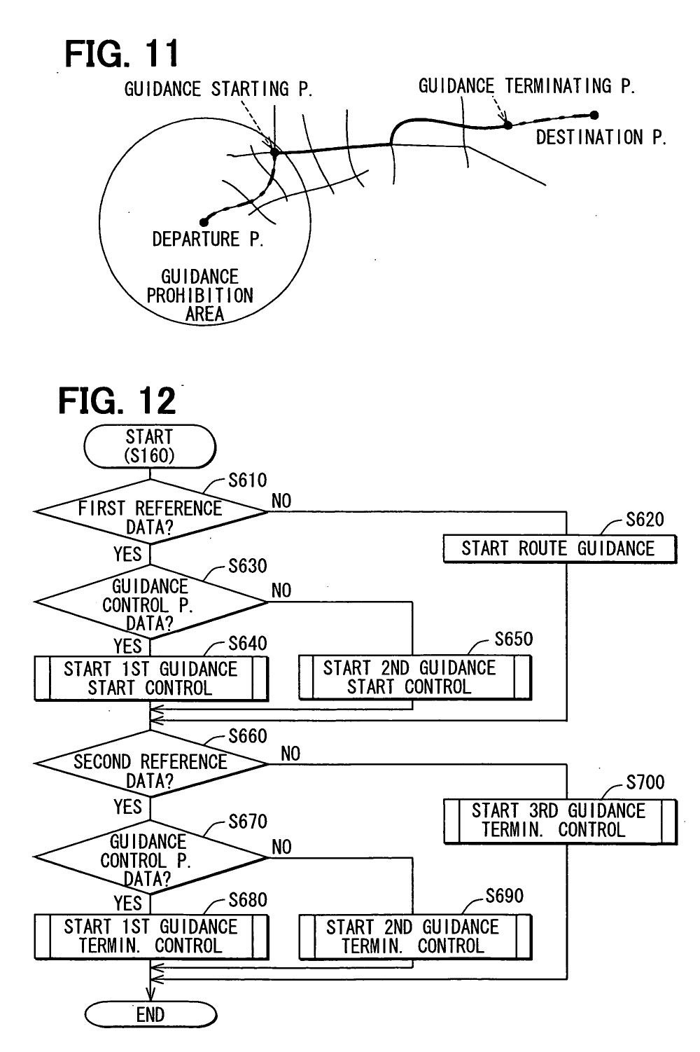

Meanwhile, when the control unit 25 determines that the first reference data is guidance prohibition area data (Yes at S520), it proceeds to S540. Then, it sets the following as the starting point for route guidance (guidance starting point): the intersection (point at which roads cross) that exists on the directed route positioned inside the guidance prohibition area indicated by the first reference data and is closest to the point of intersection between the outer border of this guidance prohibition area and the directed route. (Refer to FIG. 11.) In cases where there is no pertinent intersection, however, the control unit 25 sets the start point of the directed route as the guidance starting point. After the completion of the processing of S540, it proceeds to S550.

After proceeding to S550, the control unit 25 determines whether or not second reference data has been set, as in the processing of S450. When it determines that second reference data has been set (Yes at S550), it proceeds to S560. When it determines that second reference data has not been set (No at S550), it proceeds to S570.

After proceeding to S560, the control unit 25 determines whether or not the second reference data set by the processing to set a destination guidance unwanted area previously carried out is guidance prohibition area data. When it determines that the second reference data is not guidance prohibition area data (No at S560), it proceeds to S570. At S570, the control unit 25 sets the end point of the directed route (the end point set at S470 or S480) as the terminating point for route guidance (guidance terminating point). Thereafter, it proceeds to S590.

Meanwhile, when the control unit 25 determines that the second reference data is guidance prohibition area data (Yes at S560), it proceeds to S580. Then, it sets the point of intersection between the outer border of the guidance prohibition area indicated by the second reference data and the directed route as the terminating point for route guidance (guidance terminating point). In cases where there is no point of intersection, however, the control unit 25 sets the end point of the directed route as the guidance terminating point. After the completion of S580, it proceeds to S590.

After proceeding to S590, the control unit 25 causes the display unit 21 to display the guided route notification screen to notify the user of a guided route about which route guidance is to be provided within the set directed route. The guided route is from the guidance starting point set at S530 or S540 to the guidance terminating point set at S570 or S580. FIG. 11 is an explanatory drawing illustrating the construction (example) of the guided route notification screen displayed on the display unit 21.

As illustrated in FIG. 11, the guided route notification screen shows the guided route from the guidance starting point to the guidance terminating point within the directed route from the departure point (the current position of the vehicle) to the destination point. This guided route is indicated by heavy line or the like over a map of the peripheral area. In this drawing, the combination of the heavy line and the broken line represents the directed route. In FIG. 11, route sections of the directed route that are not included in the guided route are indicated by broken line. In the actual guided route notification screen, however, broken lines are not displayed. However, the route sections of the directed route that are not included in the guided route may be shown in the guided route notification screen in such a manner than they can be distinguished from the guided route.

After the control unit 25 displays the guided route notification screen at S590, it waits until the following takes place: the user checks the guided route based on this guided route notification screen and inputs a command to start route guidance or a command to search for any other route through the operation switch group 13, the remote 15a, or the like. When a command to search for any other route is inputted from the user, the control unit 25 closes the guided route notification screen. It makes a negative determination at S593, and proceeds to S597. At S597, the control unit 25 searches for routes that are extended from the start point to the end point previously set at S430, S440, S470, and S480 and are different from the already set directed route, and sets a new directed route again. Thereafter, it proceeds to S510.

Meanwhile, when a command to start route guidance is inputted, the control unit 25 closes the guided route notification screen, makes an affirmative determination at S593, and terminates this guided route notification processing. In conjunction with this, it terminates the route search and notification processing.

After the control unit 25 terminates the above-mentioned route search and notification processing at S150, it proceeds to S160 and carries out the processing to control turn-on/off of route guidance, illustrated in FIG. 12.

(iv) Processing to Control Turn-On/Off of Route Guidance

FIG. 12 is a flowchart illustrating the processing to control turn-on/off of route guidance carried out by the control unit 25.

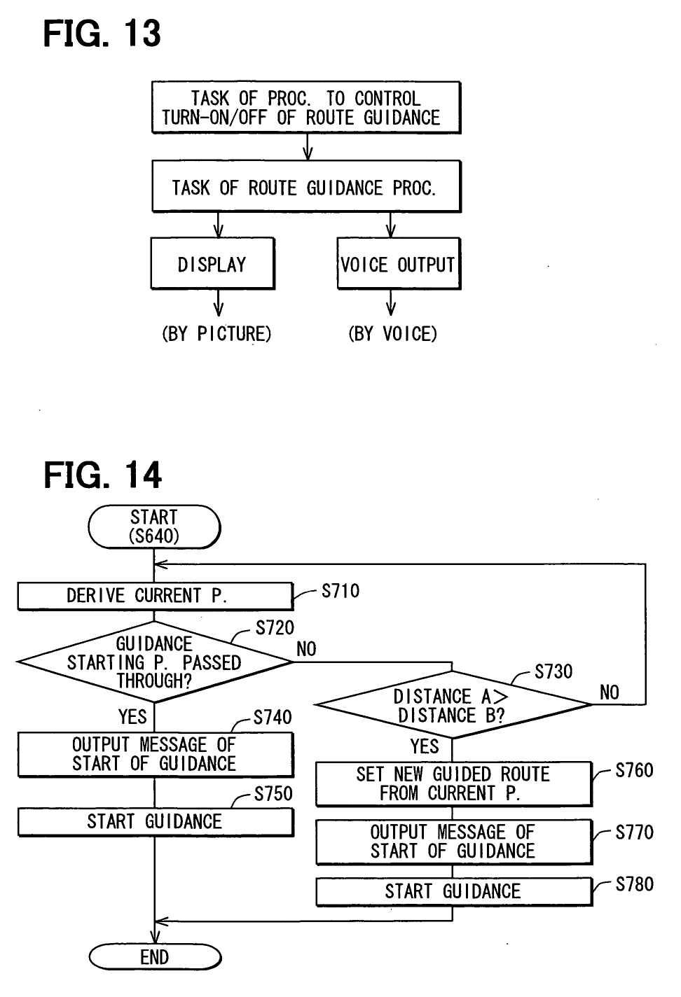

When the processing to control turn-on/off of route guidance is started, the control unit 25 determines whether or not first reference data has been set, as in the processing of S410 (S610). When it determines that first reference data has not been set (No at S610), it starts the program for implementing route guidance. After starting route guidance (S620), the control unit 25 proceeds to S660. That is, as illustrated in FIG. 13, it generates a task of route guidance processing, aside from the task of the processing to control turn-on/off of route guidance, and starts the route guidance processing in parallel with this processing to control turn-on/off of route guidance.

In the task of route guidance processing in this embodiment, route guidance is basically provided by the same technique as in publicly known automobile navigation systems.

That is, in the task of route guidance processing, voice guidance is provided through the voice output unit 23 with respect to the following: points at which the vehicle should make a right or left turn, junctions, crossroads, entrances to and exists from turnpike roads, and the like. Thus, the user can drive his/her vehicle along the directed route (guided route) from a preset guidance starting point to a preset guidance terminating point. In addition to this voice guidance, the guided route is displayed by heavy line or the like over a map of the area around the current position of the vehicle displayed on the display unit 21. When the vehicle approaches an intersection or the like at which the vehicle is supposed to make a turn, the route guidance screen is displayed on the display unit 21. This screen shows the three-dimensional image of the peripheral area, together with the direction of the turn of the vehicle. In cases where the user drives off the guided route, the control unit 25 sets a guided route from the current position of the vehicle to the guidance terminating point again. When a route is set again, however, routes to the guidance terminating point, not to the destination point specified by the user, are searched for.

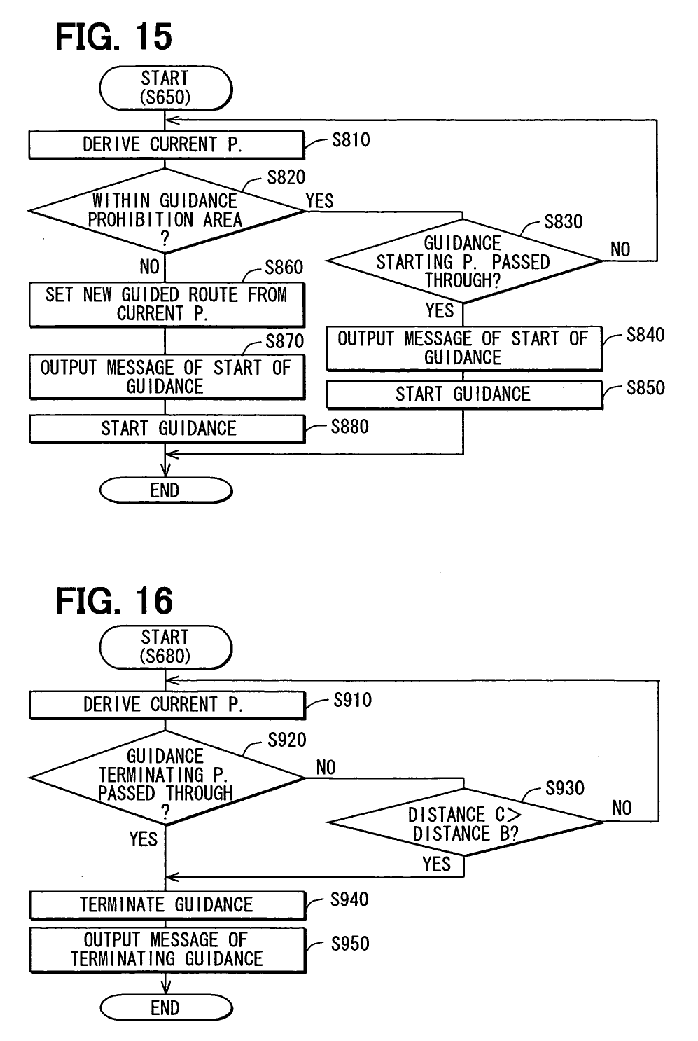

When, at S610, the control unit 25 determines that first reference data has been set (Yes at S610), it proceeds to S630 and determines whether or not the first reference data is guidance control point data. When it determines that the first reference data is guidance control point data (Yes at S630), it proceeds to S640 and carries out the first processing to control the start of guidance, illustrated in FIG. 14. When it determines that the first reference data is not guidance control point data (No at S630), it proceeds to S650 and carries out the second processing to control the start of guidance, illustrated in FIG. 15. FIG. 14 is a flowchart illustrating the first processing to control the start of guidance carried out by the control unit 25, and FIG. 15 is a flowchart illustrating the second processing to control the start of guidance carried out by the control unit 25.

After starting the first processing to control the start of guidance at S640, the control unit 25 derives the current position of the vehicle at S710, and then it carries out the following processing at S720: the control unit 25 determines whether or not the vehicle has passed through the guidance starting point based on the current position of the vehicle and the record of the running of the vehicle up to the current position.

When the control unit 25 determines that the vehicle has not passed through the guidance starting point (No at S720), it proceeds to S730. Here, the control unit 25 determines distance A and distance B and determines whether or not the distance B is shorter than the distance A. The distance A is obtained by subtracting a constant a from the direct distance from the guidance starting point to the destination point; the distance B is a direct distance from the current position of the vehicle to the destination point. The constant a can be arbitrarily set by a designer and may be set to a value of zero, for example.

When, at S730, the control unit 25 determines that the distance B is equal to or longer than the distance A (No at S730), it proceeds to S710, and derives the current position of the vehicle again and carries out the processing of S720.

When the control unit 25 determines that the vehicle has passed through the guidance starting point (Yes at S720), it causes the voice output unit 23 to output a message informing that route guidance will be started, in the form of voice (S740). Thereafter, it starts the above-mentioned program for implementing route guidance and starts route guidance (S750). That is, the control unit 25 starts the route guidance processing based on the above program in parallel with the first processing to control the start of guidance (the processing to control turn-on/off of route guidance). When the control unit 25 starts route guidance at S750, it terminates the first processing to control the start of guidance and-proceeds to S660.

Meanwhile, when the vehicle does not pass through the guidance starting point and the distance B becomes shorter than the distance A because the vehicle moves to the destination point or for other like reasons, the control unit 25 makes an affirmative determination at S730. It searches for the optimum route from the current position of the vehicle to the guidance terminating point, and sets it as the guided route (S760). After the completion of this processing, the control unit 25 causes the voice output unit 23 to output a message informing that route guidance will be started, in the form of voice (S770). Thereafter, it starts the above-mentioned program for implementing route guidance, and starts route guidance with respect to the guided route set again (S780). When the control unit 25 starts route guidance at S780, it terminates the first processing to control the start of guidance and proceeds to S660.

After starting the second processing to control the start of guidance at S650, the control unit 25 derives the current position of the vehicle at S810, and then determines whether or not the current position of the vehicle is within the guidance prohibition area indicated by the first reference data, at S820. When it determines that the current position of the vehicle is within the guidance prohibition area indicated by the first reference data (Yes at S820), it proceeds to S830. At S830, the control unit 25 determines whether or not the vehicle has passed through the guidance starting point based on the current position of the vehicle and the record of the running of the vehicle up to the current position. When it determines that the vehicle has not passed through the guidance starting point (No at S830), it proceeds to S810, and derives the current position of the vehicle again and carries out the processing of S820 and S830.

When the control unit 25 determines that the vehicle has passed through the guidance starting point (Yes at S830), it causes the voice output unit 23 to output a message informing that route guidance will be started, in the form of voice (S840). Thereafter, it starts the above-mentioned program for implementing route guidance, and starts route guidance (S850). That is, the control unit 25 starts the route guidance processing in parallel with the second processing to control the start of guidance (the processing to control turn-on/off of route guidance). When the control unit 25 starts route guidance at S850, it terminates the second processing to control the start of guidance and proceeds to S660.

Meanwhile, when the vehicle does not pass through the guidance starting point and the current position of the vehicle gets out of the guidance prohibition area indicated by the first reference data because the vehicle moves to the destination point or for other like reasons, the control unit 25 makes a negative determination at S820. It searches for the optimum route from the current position of the vehicle to the guidance terminating point, and sets it as the guided route (S860). After the completion of this processing, the control unit 25 causes the voice output unit 23 to output a message informing that route guidance will be started, in the form of voice (S870). Then, it starts the above-mentioned program for implementing route guidance, and starts route guidance with respect to the guided route set again (S880). When the control unit 25 starts route guidance at S880, it terminates the second processing to control the start of guidance and proceeds to S660.

After proceeding to S660, the control unit 25 determines whether or not second reference data has been set, as in the processing of S450. When it determines that second reference data has been set (Yes at S660), it proceeds to S670 and determines whether or not the second reference data is guidance control point data.

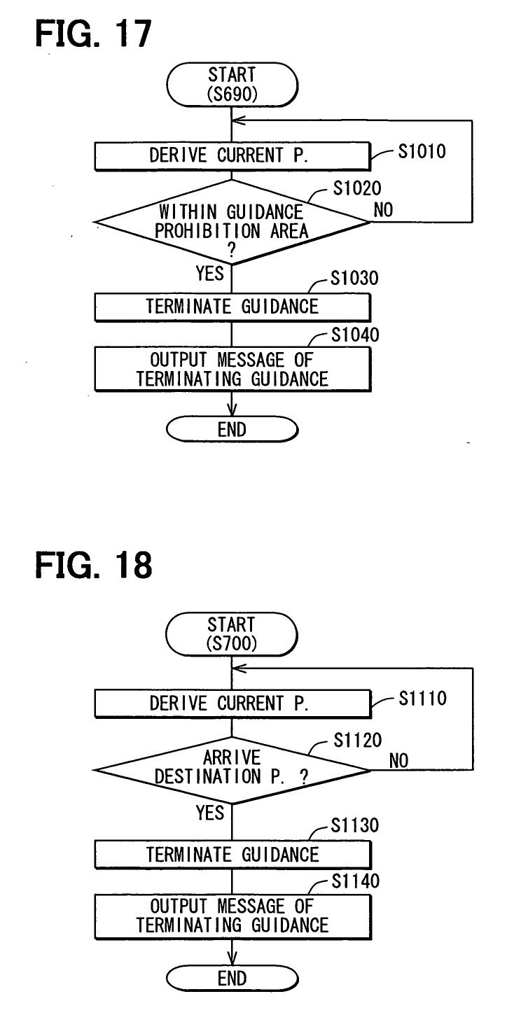

When the control unit 25 determines that the second reference data is guidance control point data (Yes at S670), it carries out the first processing to control the termination of guidance, illustrated in FIG. 16, at S680. When the control unit 25 determines that the second reference data is not guidance control point data (in other words, the second reference data is guidance prohibition area data) (No at S670), it carries out the second processing to control the termination of guidance, illustrated in FIG. 17, at S690. FIG. 16 is a flowchart illustrating the first processing to control the termination of guidance carried out by the control unit 25, and FIG. 17 is a flowchart illustrating the second processing to control the termination of guidance carried out by the control unit 25.

After starting the first processing to control the termination of guidance at S680, the control unit 25 derives the current position of the vehicle at S910. At S920, thereafter, it determines whether or not the vehicle has passed through the guidance terminating point based on the current position of the vehicle and the record of the running of the vehicle up to the current position.

When the control unit 25 determines that the vehicle has not passed through the guidance terminating point (No at S920), it proceeds to S930. Here, the control unit 25 determines distance C and distance B and determines whether or not the distance B is shorter than the distance C. The distance C is obtained by subtracting a constant β from the direct distance from the guidance terminating point to the destination point; the distance B is a direct distance from the current position of the vehicle to the destination point. The constant β can be arbitrarily set by a designer and may be set to a value of zero, for example.

When, at S930, the control unit 25 determines that the distance B is equal to or longer than the distance C (No at S930), it proceeds to S910, and derives the current position of the vehicle again and carries out the processing of S920.

When the control unit 25 determines that the vehicle has passed through the guidance terminating point (Yes at S920) or the distance B is shorter than the distance C (Yes at S930), it proceeds to S940 and terminates the task of route guidance processing. Then, it terminates the route guidance by voice and picture it has carried out up to now. After the completion of this processing, the control unit 25 causes the voice output unit 23 to output a message informing that route guidance has been terminated, in the form of voice (S950). Thereafter, it terminates this first processing to control the termination of guidance. In conjunction with this, it terminates the processing to control turn-on/off of route guidance and navigation control processing.

After starting the second processing to control the termination of guidance at S690, the control unit 25 derives the current position of the vehicle at S1010, and then it carries out the following processing at S1020: the control unit 25 determines whether or not the current position of the vehicle is within the guidance prohibition area indicated by the second reference data. When it determines that the current position of the vehicle is out of the guidance prohibition area indicated by the second reference data (No at S1020), it derives the current position of the vehicle again (S1010) and carries out the processing of S1020.

When the control unit 25 determines that the current position of the vehicle is within the guidance prohibition area indicated by the second reference data (Yes at S1020), it terminates the task of route guidance processing. Then, it terminates the route guidance by voice and picture it has carried out up to now (S1030). After the completion of this processing, the control unit 25 causes the voice output unit 23 to output a message informing that route guidance has been terminated, in the form of voice (S1040). Thereafter, it terminates this second processing to control the termination of guidance. In conjunction with this, it terminates the processing to control turn-on/off of route guidance and navigation control processing.

When, at S660, the control unit 25 determines that second reference data has not been set (No at S660), it carries out the third processing to control the termination of guidance, illustrated in FIG. 18, at S700. FIG. 18 is a flowchart illustrating the third processing to control the termination of guidance carried out by the control unit 25.

After starting the third processing to control the termination of guidance, the control unit 25 derives the current position of the vehicle at S1110, and then determines whether or not the vehicle has arrived at the destination point, at S1120. When it determines that the vehicle has not arrived at the destination point (No at S1120), it derives the current position of the vehicle again (S1110) and carries out the processing of S1120.

Meanwhile, when, at S1120, the control unit 25 determines that the vehicle has arrived at the destination point (Yes at S1120), it terminates the task of route guidance processing and terminates the route guidance by voice and picture it has carried out up to now (S1130). After the completion of this processing, the control unit 25 causes the voice output unit 23 to output a message informing that route guidance has been terminated, in the form of voice (S(144). Thereafter, it terminates this third processing to control the termination of guidance, and further terminates the processing to control turn-on/off of route guidance and navigation control processing.

As explained in the above, the control unit 25 carries out the processing described below. In cases where the first reference data is guidance control point data, it sets the route section from the departure point to the point at which route guidance is to be turned on/off, indicated by guidance control point data, as a nonexecution area for route guidance, as illustrated in FIG. 2B. The control unit 25 does not provide route guidance with respect to this nonexecution area for route guidance. After the vehicle gets out of the nonexecution area, it starts route guidance.

In cases where the second reference data is guidance control point data, the control unit 25 sets the route section from the destination point to the point at which route guidance is to be turned on/off, indicated by guidance control point data, as a nonexecution area for route guidance, as illustrated in FIG. 2C. When the vehicle arrives at this nonexecution area for route guidance, the control unit 25 terminates route guidance.

In cases where the first reference data is guidance prohibition area data, the control unit 25 sets the route section from the departure point to the outer border of the guidance prohibition area as a nonexecution area for route guidance, as illustrated in FIG. 3B. (In more detail, the outer border of the guidance prohibition area is the intersection immediately before the outer border of the guidance prohibition area.) The control unit 25 does not provide route guidance with respect to this nonexecution area for route guidance. When the vehicle gets out of the nonexecution area, it starts route guidance.

In cases where the second reference data is guidance prohibition area data, the control unit 25 sets the route section from the destination point to the outer border of the guidance prohibition area as a nonexecution area for route guidance, as illustrated in FIG. 3C. The control unit 25 does not provide route guidance with respect to this nonexecution area for route guidance. When the vehicle arrives at this nonexecution area, it terminates route guidance.

Up to this point, description has been given of an automobile navigation system 1 in this embodiment. This automobile navigation system 1 does not provide route guidance by voice and picture with respect to the following: an area specified by the user through information on a radius from the departure point and an area specified by the user through information on a radius from the destination point. Therefore, it can be avoided to provide route guidance unnecessary for the user in proximity to a departure point and in proximity to a destination point. Thus, the user can be freed from being stressed by unwanted route guidance.

In the automobile navigation system 1 in this embodiment, especially, it can be avoided to provide unwanted route guidance with respect both to route guidance by voice and to route guidance by picture through the display unit 21. Therefore, the user can be freed from being stressed by unwanted voice output and further being stressed by screen updating associated with route guidance.

In conventional systems as well, route guidance in proximity to a true destination point can be omitted when the user considers route guidance in proximity to the destination point unnecessary. This is done by specifying some point (a point at which the user desires to terminate route guidance) other than the true destination point as a destination point on the automobile navigation system. However, conventional systems involve a problem. In cases where the vehicle does not arrive at a specified destination point, an auto rerouting function makes an attempt to correct the guided route. Therefore, the user must pass through the specified destination point without fail before moving to the true destination point.

The automobile navigation system 1 in this embodiment brings the following advantage: when the vehicle arrives at a guidance prohibition area in proximity to a destination point, it terminates route guidance regardless of where the vehicle enters the guidance prohibition area from. In this system, therefore, route guidance unnecessary for the user can be dramatically suppressed as compared with conventional systems.

In this automobile navigation system 1, information on guidance prohibition areas specified by the user is registered in the guidance prohibition area database. Therefore, it is unnecessary for the user to specify an identical guidance prohibition area (radius, etc.) each time he/she inputs a route guidance command. Therefore, with this automobile navigation system 1, stress on the user associated with specifications of guidance prohibition areas can be minimized.

The automobile navigation system 1 in this embodiment is so constructed that the user can pinpointedly specify the starting point and terminating point for route guidance. As a result, route guidance can be started and terminated as the user desires. With this automobile navigation system 1, therefore, the user can be sufficiently freed from being stressed by unwanted route guidance.

The automobile navigation system 1 in this embodiment is so constructed that route guidance is started or terminated when a specific condition is satisfied even if the vehicle does not pass through the above-mentioned starting point or terminating point for route guidance, specified by the user.

In this embodiment, therefore, it can be avoided to provide unwanted route guidance even when the user does not drive his/her vehicle along a preset route. Thus, the user can be sufficiently freed from being stressed by provision of unwanted route guidance. Even when the vehicle does not pass through the starting point for route guidance, it is possible to start route guidance in a timely manner and appropriately provide route guidance the user desires.

The routing assistance system or program of the invention is not limited to the above-mentioned embodiment, and they can be embodied in various modes.

Some examples will be taken up. In the above-mentioned embodiment, the following processing is carried out to make the user select data to be set as first and second reference data: a list of the pieces of guidance control point data and guidance prohibition area data as the candidates of the first and second reference data is shown in the setting screen for departure point guidance unwanted area and the setting screen for destination guidance unwanted area. Instead, the automobile navigation system 1 may be so constructed that the following processing is carried out: data optimum as first and second reference data is automatically selected from among the pieces of guidance control point data and guidance prohibition area data read out from the respective databases, and they are set as the first and second reference data.

For example, the automobile navigation system 1 may be so constructed that the following processing is carried out: in a constellation of data read out, the guidance control point data indicating a point closest to the departure point or the guidance prohibition area data indicating a central point closest to the departure point is set as first reference data; and the guidance control point data indicating a point closest to the destination point or the guidance prohibition area data indicating a central point closest to the destination point is set as second reference data.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

It will be obvious to those skilled in the art that various changes may be made in the above-described embodiments of the present invention. However, the scope of the present invention should be determined by the following claims.

What is claimed is:

1. A routing assistance system comprising:
a route setting means that sets a route from a departure point to a destination point;
a route guidance means that provides route guidance;
an acquiring means that acquires unwanted-area information that represents an area for which route guidance is unwanted; and
a point setting means that sets, within the route set by the route setting means, a guidance starting point and a guidance terminating point in the route, based on the acquired unwanted-area information, wherein
the route guidance means selectively provides route guidance with respect to a route from the guidance starting point to the guidance terminating point.

2. The routing assistance system according to claim 1, wherein
the area represented by the unwanted-area information includes the departure point or the destination point as a base point.

3. The routing assistance system according to claim 1, further comprising:
a determining means that executes a determination of whether or not the destination point is approached without the guidance staring point passed through, wherein,
when the determination is affirmed, the route setting means sets a new route from a current position to the destination point and the route guidance means starts route guidance with respect to the new route.

4. The routing assistance system according to claim 1, further comprising:
a determining means that executes a determination of whether or not a destination point is approached without the guidance terminating point passed through, wherein,
when the determination is affirmed, the route guidance means terminates route guidance.

5. The routing assistance system according to claim 1, wherein
the route guidance means informs that route guidance is to be started and that route guidance will be terminated.

6. A method used in a routing assistance system, the method comprising:
setting a route from a departure point to a destination point;
acquiring unwanted-area information that represents an area for which route guidance is unwanted;
setting, within the set route, a guidance starting point and a guidance terminating point in the route, based on the acquired unwanted-area information; and
providing route guidance with respect to a route from the guidance starting point to the guidance terminating point.

7. A routing assistance system comprising:
a route setting unit that sets a route from a departure point to a destination point;
a route guidance unit that provides route guidance with respect to the route;
an acquiring unit that acquires unwanted-area information that represents an area for which route guidance is unwanted; and
a point setting unit that sets, within the route set by the route setting unit, a guidance starting point and a guidance terminating point in the route, based on the acquired unwanted-area information, wherein
the route guidance unit selectively provides route guidance with respect to a route from the guidance starting point to the guidance terminating point.
